(19) United States
(12) Patent Application Publication
(10) Pub. No.: US 2010/0136888 A1
(43) Pub. Date: Jun. 3, 2010

(54) Abrasive for a Pressure Fluid Jet in a Jet Cutter

(76) Inventor: Luigi Bettazza, Monza (IT)

Correspondence Address: AKERMAN SENTERFITT, P.O. BOX 3188, WEST PALM BEACH, FL, 33402-3188, US

(21) Appl. No.: 12/415,219

(22) Filed: Mar. 31, 2009

(30) Foreign Application Priority Data
Nov. 28, 2008 (EP) 08425764.1

(51) Int. Cl. B24C 11/00; B02C 17/00; B02C 23/08; C09K 3/14

(52) U.S. Cl. 451/38; 241/24.1; 241/29; 51/308

(57) ABSTRACT

An abrasive for a jet of fluid under pressure in a jet cutting machine, which obtains a high cutting speed and reduced operating cost for the machine, consists of ground quarry quartz granules.

### FIELD OF APPLICATION

The present invention relates to an abrasive for a pressure fluid jet in a jet cutter.

### PRIOR ART

As known, jet cutting machines or jet cutters are widely used, wherein a jet of fluid under pressure, typically water, is directed on a sheet of a given thickness and a given material, which should be cut along a given profile. In the case of some materials, such as for example rubber, the cutting action may be carried out simply by the fluid jet. But when the sheet material exhibits certain hardness, it is necessary to mix the jet with a granular abrasive before it exits the calibrated machine nozzle, which abrasive is preferably distributed at the outer shell of the jet and increases the erosion power and thus the cutting capability thereof. In this way it is possible to cut sheets of virtually any material, except for hardened glass sheets and few other materials.

However, it should be noted that the operating cost of the jet cutting machine is much overloaded by the mixing of the granular abrasive to the fluid jet. In fact, the abrasive currently used, also with satisfactory cutting capability for its hardness, that is almandine, affects the operating cost of the machine by about forty percent.

In fact, almandine is relatively difficult to find, as it is available in large sedimentary bodies but all out of the way. These sedimentary bodies are in river beaches in Australia, and in sea beaches in India, China and South-Africa. Moreover, almandine has obtained from sea beaches further requires one additional operation for washing salt deposits away.

Due to the high cost, almandine is reused, only by about 40%, for making subsequent cuts, while the remaining prevailing part, about 60%, is disposed of with the disposal code CER 120117.

As known, almandine has the formula Fe3Al2(SiO4)3, and is an iron and aluminium orthosilicate with specific weight of about 4 g/cm3 and hardness comprised between 7.5 and 8, according to the Mohs scale.

The use of quartzose sand as an abrasive for a fluid jet has been attempted, which quartzose sand is widely available, also in river sedimentary bodies, and widely used in other fields of the art, such as that of building materials. However, no satisfactory results were obtained: in fact, the cutting speed, that is, the speed at which the jet cuts through the sheet along the path to be cut, did not exceed about 20% of the cutting speed obtained with almandine, of course all the other conditions being equal.

The problem at the basis of the present invention is to provide an abrasive for the specified use which should solve the disadvantages mentioned with reference to the known art.

### SUMMARY OF THE INVENTION

Such a problem is solved by an abrasive which is characterised in that it consists of ground quartz granules.

In particular, said quartz is quarry quartz. Moreover, said granules have a size comprised between 0.15 mm and 0.8 mm, and preferably comprised between 0.3 mm and 0.4 mm. Advantageously, said granules may have a flat or concave face body and a sharp edge body. The problem is also solved by a method for obtaining an abrasive for use in a fluid jet in a jet cutting machine, characterised in that it comprises the quartz grinding step with yield of ground quartz granules.

Moreover, the method may comprise the step of sieving the ground quartz with removal of granules having a size smaller than 0.15 mm.

Moreover, the method may comprise the step of cleaning the ground quartz with removal of the powdery fraction.

The grinding step advantageously comprises a first grinding in a hammer mill, with yield of a size around 5-8 mm, and a second grinding in a ball mill, with roughing balls and finishing balls.

Further features and advantages of the abrasive according to the present invention will appear more clearly from the following description, given by way of a non-limiting example with reference to the annexed figures, wherein:

### BRIEF DESCRIPTION OF THE DRAWINGS

FIG. 1 shows a photographic enlarged view of the abrasive according to the invention;

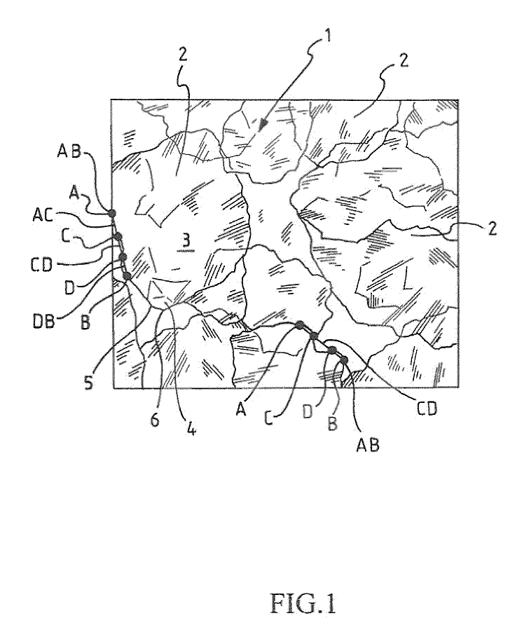

FIG. 2 shows a further photographic enlarged view of the abrasive according to the invention.

### DETAILED DESCRIPTION

With reference to the annexed figures, an abrasive according to the invention, globally indicated with 1, for a jet of fluid under pressure, in a jet cutting machine, consists of ground quartz granules 2. By the term ground it is meant finely divided by mechanical crushing, with the consequent resulting conchoidal fracture typical of quartz.

In particular, such quartz granules 2 are obtained by grinding quarry quartz.

Granules 2 exhibit a body 3 wherein faces 4, edges 5 and vertices 6 are schematically shown. Faces 4 are generally substantially flat or concave, with shell-like concavity typical of the conchoidal fracture, and are accidentally convex. Edges 5 generally are sharp and acute, and only accidentally they are smoothed or obtuse. Vertices 6 generally are substantially sharp and only accidentally they are rounded or smoothed.

In practice, geometrically speaking, bodies 3 are solids that may be defined as not connected, that is, such that taken two points A and B of the solid, segment AB that connects the two points A and B is not all belonging to the solid, but by a portion AC and by a portion DB it belongs to the solid, whereas by a residual intermediate portion CD it extends beyond the solid.

Granules 2 exhibit a grain size comprised between 0.15 mm and 0.8 mm, most of the granules being comprised between 0.3 and 0.4 mm.

Preferably, the presence of particles of a size smaller than 0.15 mm, as well as of a powdery fraction, is also to be excluded. In terms of grain, that is, number of wires in a mesh per linear inch, the grain is comprised between M110 and M20, preferably between M50 and M40.

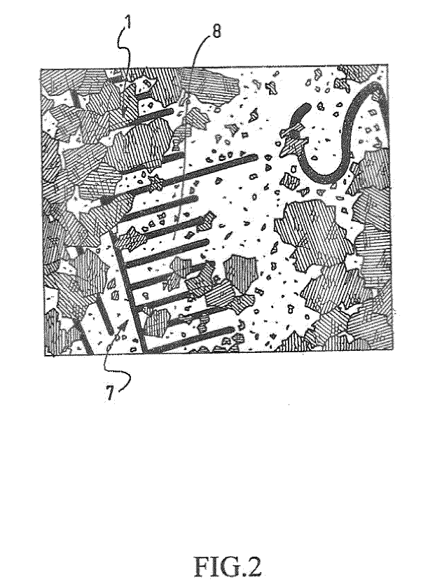

It should be noted that a graduated rule 7 is also pictured in FIG. 2, with divisions 8 of 0.2 mm true width.

Granules 2 of abrasive 1 according to the invention are obtained by grinding quarry quartz, in a first step in a hammer mill, with yield of a size around 5-8 mm, and then in a ball mill with roughing balls of around 18 cm and with finishing balls of around 6 cm. The grinding is followed by sieving to remove particles smaller than 0.15 mm, and cleaning, preferably washing, to remove the powdery fraction.

During the cutting action, the quartz granules, thanks to the conchoidal fracture thereof, act as tools, with often negative rake cutting edges, increasing the erosion capability of the jet of fluid under pressure towards the material to be cut.

It is important to note that should the single grain, especially if arranged at the outer shell of the jet, undergo breakage subsequent to the percussion it undergoes in the first place upon the passage through the machine nozzle and after that, by the material that is cut, it would not lose the cutting capability at all, thanks to the fact that quartz has a conchoidal fracture, that is, it maintains or gains, subsequent to percussion, the face concavity.

From tests made with the abrasive according to the invention it was possible to cut at a speed substantially equal to the speed obtained with almandine.

The use of the abrasive according to the present invention allowed achieving the important advantage of an excellent cutting speed in jet cutting machines, with a sensible reduction of the operating cost thereof, in practice with a halving of the cost due to the abrasive.

A further advantage of the abrasive according to the invention is that it allows easily maintaining the required conditions of environmental hygiene of cutting machines. In any case the smallest silica particles, in the range of few thousandths millimetres, which may be harmful to health, are not found.

A further advantage of the abrasive according to the invention is that it is suitable for being used on existing jet cutting machines.

The abrasive according to the invention is suitable for being packaged and carried in big substantially cubic bags with dimensions of the side of about 100 cm, already used for known abrasives, with the advantage of a lighter weight thanks to the lower specific weight.

A further advantage of the abrasive according to the invention is that after use, it is a recoverable material, for example in the glass industry, with a more favourable environmental impact.

It is clear that a man skilled in the art may make several changes and variations to the abrasive described above in order to meet specific and incidental needs, all falling within the scope of protection of the invention as defined by the following claims.

In particular, it is to be considered as within the scope of the present invention an abrasive which comprises ground quartz granules mixed with any other suitable known material.

1. An abrasive for a jet of fluid under pressure in a jet cutting machine, consisting essentially of ground quartz granules.

2. The abrasive according to claim 1, wherein said quartz is quarry quartz.

3. The abrasive according to claim 1, wherein said granules have dimensions comprised between 0.15 mm and 0.8 mm.

4. The abrasive according to claim 1, wherein said granules have dimensions comprised between 0.3 mm and 0.4 mm.

5. The abrasive according to claim 1, wherein said granules have flat or concave face body.

6. The abrasive according to claim 1, wherein said granules have sharp edge body.

7. A method for obtaining an abrasive to use in a fluid jet in a jet cutting machine, comprising the step of:
grinding quartz to yield ground quartz granules.

8. The method according to claim 7, further comprising sieving the ground quartz with removal of granules having a size smaller than 0.15 mm.

9. The method according to claim 8, further comprising cleaning the ground quartz with removal of the powdery fraction.

10. The method according to claim 7, wherein the grinding step comprises a first grinding in a hammer mill, with yield of a size around 5-8 mm, and a second grinding in a ball mill, with roughing balls and finishing balls.

11. A method of jet cutting a material comprising the steps of:
using a jet of fluid under pressure in a jet cutting machine; and
providing an abrasive mixed in with the jet of fluid, the abrasive consisting essentially of ground quartz granules.
